(19) United States
(12) Patent Application Publication
(10) Pub. No.: US 2008/0085224 A1
(43) Pub. Date: Apr. 10, 2008

(54) Air purifier

(76) Inventor: Chun-Cheng Cheng, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/544,550

(22) Filed: Oct. 10, 2006

(51) Int. Cl. B01J 19/12

(52) U.S. Cl. 422/186.3

(57) ABSTRACT

An air purifier has a casing assembly, a shade assembly and an ultraviolet (UV) light assembly. The casing assembly has a cavity, a rear casing half, a front casing half. The front casing half is mounted on the rear casing half. The shade assembly is mounted in the cavity and has an inner front shade and an outer front shade. The inner and outer front shades are mounted on the front casing half and each has multiple air holes. The UV light assembly is mounted in the casing assembly, is covered by the shade assembly and has multiple covers and an UV light tube. The covers are arranged in a concentric arrangement and each cover has multiple apertures. The UV light tube is mounted in an innermost one of the covers. The shade assembly effectively prevents the UV from leaking out to harm people.

### BACKGROUND OF THE INVENTION

1. Field of the Invention

The present invention relates to a purifier, and more particularly to an air purifier that prevents ultraviolet (UV) inside the air purifier from leaking out excessively.

2. Description of Related Art

People stay indoors for a long time everyday. The indoor air quality effectively influences human healthy. Articles with organic compounds such as formaldehyde, benzene and ammonia, mold, germs and smells of paint, shoes and carpet in the air deteriorate the air quality and make people staying indoors feel uncomfortable.

Therefore, air purifiers have been developed to purify the indoor air and improve human healthy. A conventional air purifier has an ultraviolet (UV) generator and a shade. The shade is coated with a photo-catalyzer coating made of titanium dioxide (TiO₂) and covers partially the UV light tube. When the air purifier is in use, the TiO₂ absorbs UV radiated from the UV light tube and reacts with hydrogen oxide (H₂O) in the air to generate hydroxyl radicals to decompose germs and mold and deodorize articles such as shoes, clothes and furniture.

However, partial UV from the UV light tube passes through the shade and is radiated on nearby people to make them feel uncomfortable and even get skin disease.

To overcome the shortcomings, the present invention provides an air purifier to mitigate or obviate the aforementioned problems.

### SUMMARY OF THE INVENTION

The main objective of the invention is to provide an air purifier that prevents ultraviolet (UV) inside the air purifier from leaking out excessively.

An air purifier in accordance with the present invention comprises a casing assembly, a shade assembly and an ultraviolet (UV) light assembly.

The casing assembly has a cavity, a rear casing half, a front casing half. The front casing half is mounted on the rear casing half.

The shade assembly is mounted in the cavity and has an inner front shade and an outer front shade. The inner and outer front shades are mounted on the front casing half and each has multiple air holes.

The UV light assembly is mounted in the casing assembly and is covered by the shade assembly and has multiple covers and an UV light tube. The covers are arranged in a concentric arrangement and each cover has multiple apertures. The UV light tube is mounted in an innermost one of the covers.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an air purifier in accordance with the present invention;

FIG. 2 is an exploded perspective view of the air purifier in FIG. 1 with another top cap;

FIG. 3 is a cross sectional side view of the air purifier in FIG. 2;

FIG. 4 is an exploded perspective view of the air purifier in FIG. 2 with another top shade;

FIG. 5 is an exploded perspective view of the air purifier in FIG. 2 with another top shade and an exhausting fan;

FIG. 6 is a perspective view of the ultraviolet (UV) light assembly of the air purifier in FIG. 2; and

FIG. 7 is an exploded perspective view of the UV light assembly of the air purifier in FIG. 6.

### DETAILED DESCRIPTION OF THE PREFERRED EMBODIMENT

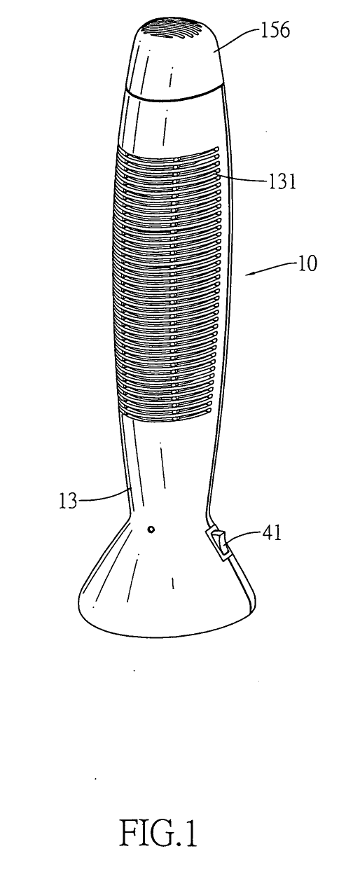

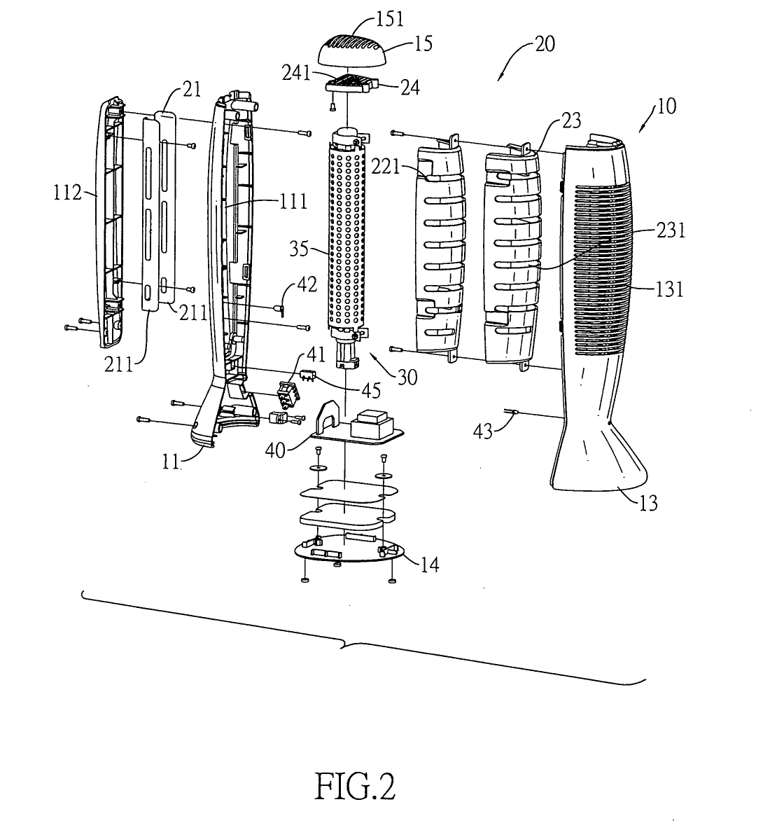

With reference to FIGS. 1 and 2, a first embodiment of an air purifier in accordance with the present invention comprises a casing assembly (10), a shade assembly (20), an ultraviolet (UV) light assembly (30), and a printed circuit board (PCB) (40).

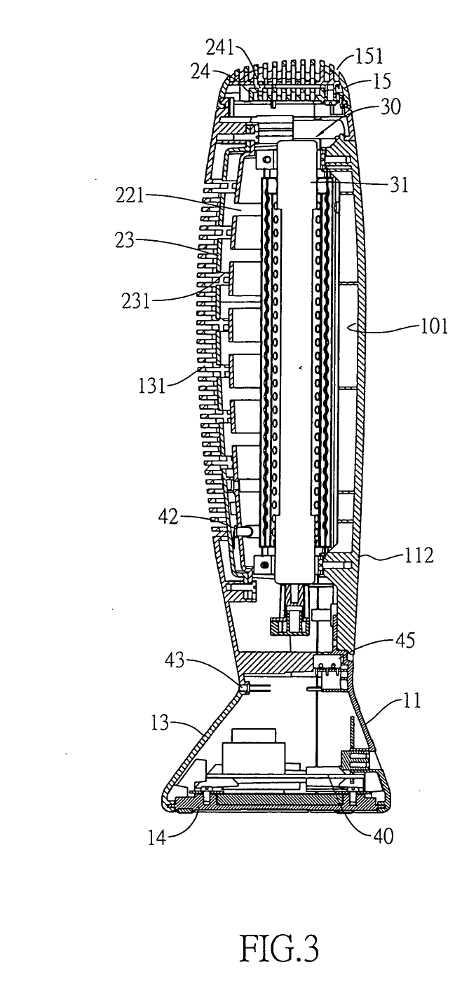

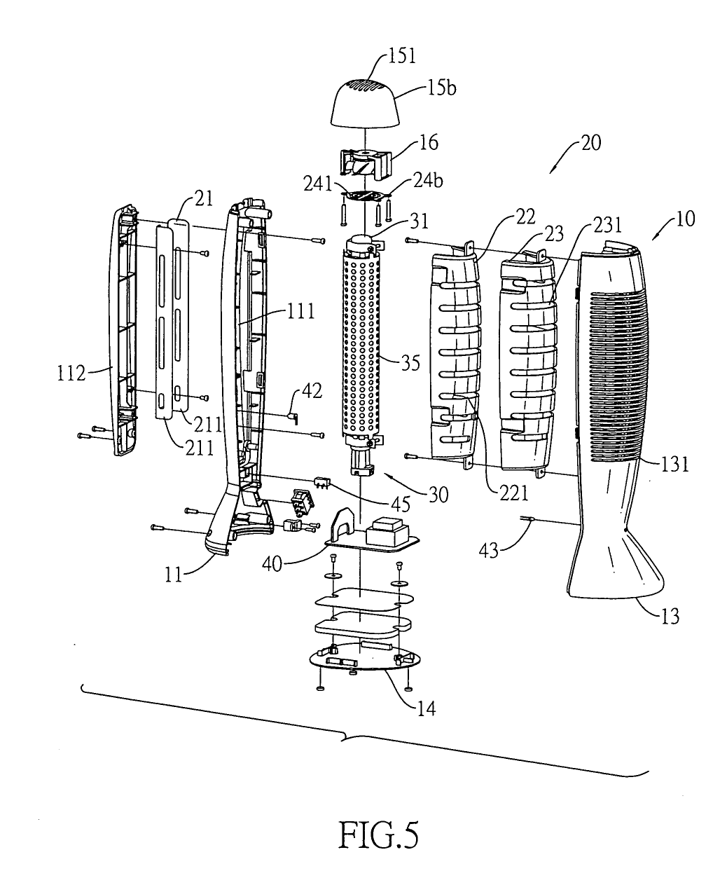

With further reference to FIGS. 3 and 5, the casing assembly (10) has a cavity (101), a rear casing half (1 1), a front casing half (13), a bottom plate (14) and atop cap (15, 15b).

The cavity (101) is defined in the casing assembly (10).

The rear casing half (11) has a top, a bottom and may have a mounting slot (111) and a mounting bracket (112). The mounting slot (111) is defined through the rear casing half (11). The mounting bracket (112) is mounted in the mounting slot (111) and has an inside surface.

The front casing half (13) is mounted on the rear casing half (11) and has a top, a bottom, an inner surface and multiple ventilation holes (131). The ventilation holes (131) are defined through the front casing half (13) and allows air in the casing assembly (10) to pass out of the front casing half (13).

The bottom plate (14) is mounted between the bottoms of the rear casing half (11) and the front casing half (13) and may have a weight. The weight is mounted on the bottom plate (14) to stably stand the air purifier.

The top cap (15, 15b) is mounted on the tops of the rear casing half (11) and the front casing half (13) and has multiple vents (151), a chamber and a fan (16). The vents (151) are defined through the top cap (15, 15b). The chamber is defined in the top cap (15, 15b) and communicates with the vents (151) and the cavity (101). The fan is mounted in the chamber and may be an intake fan or an exhaust fan.

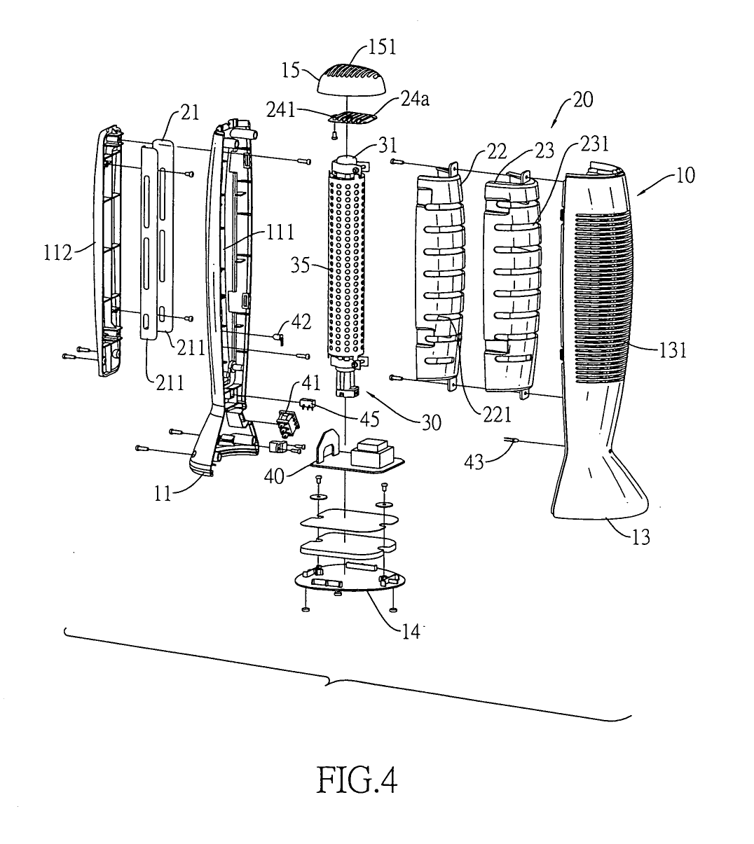

With further reference to FIG. 4, the shade assembly (20) is mounted in the cavity (101) in the casing assembly (10) and may have a rear shade (21), an inner front shade (22), an outer front shade (23) and a top shade (24, 24a, 24b).

The rear shade (21) is U-shaped, is mounted on the inside surface of the mounting bracket (112) in the cavity (101), may partially shade and prevent UV inside the rear shade (21) from passing out of the casing assembly (10) and has two opposite wings (211). The wings (211) are formed and extend from the rear shade (21) and each wing (211) has multiple air holes. The air holes are defined through the wing (211).

The inner front shade (22) is curved, is mounted on the inner surface of the front casing half (13) in the cavity (101), may partially shade and prevent UV inside the inner front shade (22) from passing out of the casing assembly (10) and has multiple air holes (221). The air holes (221) are defined through the inner front shade (22) and allow air to pass through the air holes (221).

The outer front shade (23) is curved, is mounted between the inner front shade (22) and the inner surface of the front casing half (13) in the cavity (101), may partially shade and prevent UV inside the outer front shade (23) from passing out of the casing assembly (10) and has multiple air holes (231). The air holes (231) are defined through the outer front shade (23).

The top shade (24, 24a, 24b) is mounted in chamber in the top cap (15, 15b), may be mounted under the fan (16), may partially shade and prevent UV inside the top shade (24) from passing out of the casing assembly (10) and has multiple air holes (241). The air holes (241) are defined through the top shade (24).

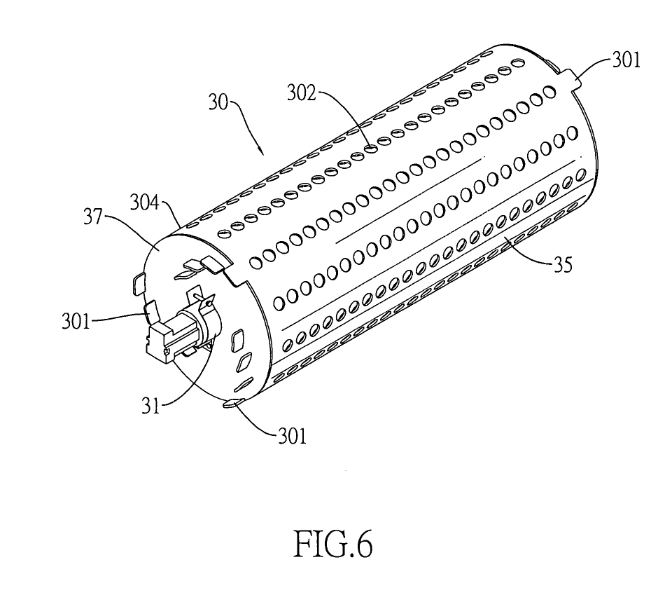

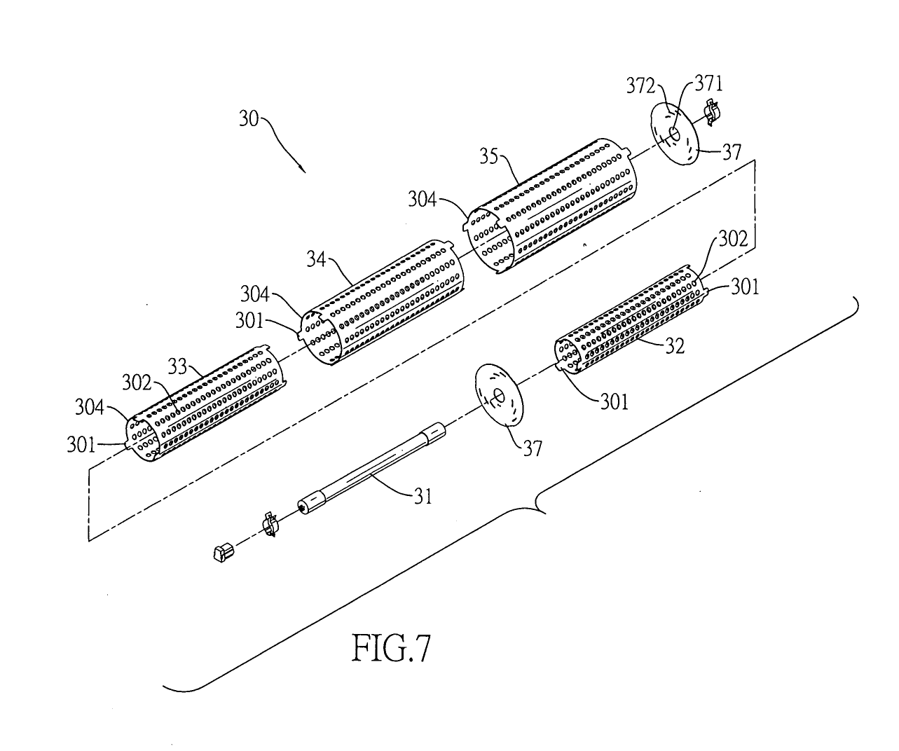

With further reference to FIGS. 6 and 7, the UV light assembly (30) is covered by the inner and outer front shades (22, 23) and the top shade (34) of the shade assembly (20), is mounted in the casing assembly (10) and may be covered by the rear shade (21). The UV light assembly (30) has two end caps (37), multiple covers (32, 33, 34, 35) and a UV light tube (31).

Each end cap (37) may have a mounting hole (371) and multiple sets of mounting slots (372). The mounting hole (371) and the sets of the mounting slots are defined through the end cap (37).

With further reference to FIG. 3, the covers (32, 33, 34, 35) are mounted between the end caps (37) and are arranged in a concentric arrangement. Each cover (32, 33, 34, 35) has a surface, two end edges and may have two sets of multiple mounting tabs (301), multiple apertures (302) and a photo-catalyzer coating (304).

The sets of the mounting tabs (301) extend respectively out from the end edges of the cover (32, 33, 34, 35) and are mounted respectively through two of the sets of the mounting slots (372) respectively in the end caps (37).

The apertures (302) are defined through the cover (32, 33, 34, 35) and allow air inside the covers (32, 23, 34, 35) containing OH radicals to pass through the apertures (302) out of the cover (32, 33, 34, 35). The apertures (302) in adjacent covers (32, 33, 34, 35) are staggered and are misaligned with each other so that the UV light is filtered partially off and weakens whenever passing out through the apertures (302) of a cover (32, 33, 34, 35). Therefore, the UV light in the covers (32, 33, 34, 35) is hardly radiated out of the covers (32, 33, 34, 35) to harm people.

The photo-catalyzer coating (304) is attached to the surface of the cover (32, 33, 34, 35) and is made of titanium dioxide (TiO₂). The photo-catalyzer coating (304) may absorb the UV light and react with hydrogen oxide (H₂O) in the air to generate OH radicals to decompose germs and mold and deodorize articles such as shoes, clothes and furniture.

The UV light tube (31) is mounted on the rear casing half (11), may be mounted on the inside surface of the mounting bracket (112), is mounted in an innermost one of the covers (32, 33, 34, 35) and generates UV light when operating. The UV light tube (31) has two ends respectively mounted through the mounting holes (371) in the end caps (37).

The operating UV light tube (10) radiates UV light to the photo-catalyzer coatings (304) on the covers (32, 33, 34, 35) and the UV light reacts with the TiO₂ to generate OH radicals for decomposition of germs and mold and deodorization of smells. Furthermore, the UV light assembly (30) in the concentric arrangement with the staggered apertures (302) in adjacent covers (32, 33, 34, 35) prevents the UV light from leaking out of the UV light assembly (30).

The PCB (40) is mounted on the bottom plate (14) in the cavity (14), connects to the UV light tube (31), has a switch (41) and may have an insulating pad, a UV sensor (42), a status light (43), a timekeeper and a reset button (45). The switch (41) connects to the PCB (40), is mounted on the casing assembly (10) and selectively turns on or off the UV light tube (31). The insulating pad is mounted under the PCB (40) to prevent a short circuit on the PCB (40). The UV sensor (42) is mounted on the PCB (40) and may detect UV light. The status light (43) is mounted on the PCB (40). When detected UV light is abnormal, the UV sensor (42) sends a signal to the PCB (40) to disable the status light (43) or change a color of the status light (43). The timekeeper is mounted on the PCB (40), may be an Electrically Erasable Programmable Read-Only Memory (EEPROM). When the EEPROM counts to 8000 hours, a signal is sent by the EEPROM to change the color the status light and indicate a user to replace the UV light tube (31). The reset button (45) is mounted on the PCB (40). After the UV light tube (31) is replaced, the user may press the reset button (45),to rest the EEPROM.

The UV light assembly (30) with the staggered apertures (302) effectively prevents the UV light from leaking out to harm people when the air purifier is in use. Furthermore, the shade assembly (20) also prevents the UV light from leaking out of the casing assembly (10). Therefore, the air purifier is safe in use and exactly benefits human body without any side effects.

What is claimed is:

1. An air purifier comprising:
a casing assembly having
a cavity defined in the casing assembly;
a rear casing half having a top and a bottom;
a front casing half mounted on the rear casing half and having a top, a bottom, an inner surface and multiple ventilation holes defined through the front casing half;
a bottom plate mounted between the bottoms of the rear casing half and the front casing half; and
a top cap mounted on the tops of the rear casing half and the front casing half and having
multiple vents defined through the top cap; and
a chamber defined through the top cap and communicating with the vents and the cavity;
a shade assembly mounted in the cavity in the casing assembly and having
an inner front shade being curved, mounted on the inner surface of the front casing half in the cavity and having multiple air holes defined through the inner front shade;
an outer front shade being curved, mounted between the inner front shade and the inner surface of the front casing half in the cavity and having multiple air hole defined through the outer front shade; and
a top shade mounted in the chamber in the top cap and having multiple air holes defined through the top shade;
an ultraviolet (UV) light assembly covered by the inner and outer front shades and the top shade of the shade assembly, mounted in the casing assembly and having
two end caps;
multiple covers mounted between the end caps, arranged in a concentric arrangement and each cover having
a surface;
two end edges;
multiple apertures defined through the cover and the apertures in adjacent covers staggered and misaligned with each other; and
a photo-catalyzer coating attached to the surface of the cover; and
a UV light tube mounted on the rear casing half and mounted in an innermost one of the covers to generate UV light when operating; and
a printed circuit board (PCB) mounted on the bottom plate in the cavity, connecting to the UV light tube and having a switch connecting to the PCB, mounted on the casing assembly to selectively turn on or off the UV light tube.

2. The air purifier as claimed in claim 1, wherein:
each end cap has a mounting hole and multiple sets of mounting slots defined through the end cap;
the UV light tube has two ends respectively mounted through the mounting holes in the end caps; and
each cover further has two sets of multiple mounting tabs extend out from the end edges of the cover and mounted respectively through two of the sets of the mounting slots respectively in the caps.

3. The air purifier as claimed in claim 2, wherein;
the rear casing half further has
a mounting slot defined through the rear casing half; and
a mounting bracket is mounted in the mounting slot and having an inside surface; and
the UV light tube is mounted on the inside surface of the mounting bracket in the rear casing half.

4. The air purifier as claimed in claim 3, wherein the shade assembly further has a rear shade mounted on the inside surface of the mounting bracket and covering the UV light assembly.

5. The air purifier as claimed in claim 4, wherein the top cap of the casing assembly further has a fan mounted in the chamber.

6. The air purifier as claimed in claim 5, wherein the fan is an intake fan.

7. The air purifier as claimed in claim 5, wherein the fan is an exhaust fan.
